(19) United States
(12) Patent Application Publication
(10) Pub. No.: US 2025/0348516 A1
(43) Pub. Date: Nov. 13, 2025

(54) Method for Drawing Geospatial Boundaries Based on Land Use

(71) Applicant: CamoAg, Inc., Palatine, IL (US)

(72) Inventors: Chris Sprehe, Crystal Lake, IL (US); Danny Tiesling, Los Angeles, CA (US)

(73) Assignee: CamoAg, Inc., Palatine, IL (US)

(21) Appl. No.: 19/094,858

(22) Filed: Mar. 29, 2025

Related U.S. Application Data
(60) Provisional application No. 63/643,967, filed on May 8, 2024.

(51) Int. Cl. G06F 16/29; G06Q 50/02

(52) U.S. Cl. CPC G06F 16/29; G06Q 50/02

(57) ABSTRACT

A method for dynamically generating a farm field boundary separating tillable acres from non-tillable acres. A location information input is received, and a map depicting an area represented by the location information is displayed. The user selects one or more land parcels from the map. A first geospatial dataset overlapping the selected parcels is retrieved, and the boundaries of the first geospatial dataset are trimmed to match the boundaries of the selected parcels. If the trimmed parcel boundaries are greater than the minimum allowed acreage, a farm field is created. A second geospatial dataset indicative of land use is retrieved, and an acreage type to is assigned to the farm field.

### CROSS REFERENCE TO RELATED APPLICATIONS

This application claims priority to U.S. Provisional Patent Application No. 63/643,967, filed on May 8, 2024, the entirety of which is hereby incorporated herein by reference.

### FIELD OF THE INVENTION

The disclosure relates generally to a method for drawing boundaries in a geospatial platform. In particular, the disclosure relates to a computer implemented method for drawing boundaries in a geospatial platform based on land use, for example by drawing geospatial boundaries identifying productive and non-productive areas or dividing the land by other land uses.

### BACKGROUND OF THE INVENTION

Overhead imagery of areas of land has become widely available and has many uses, in particular for people involved in agriculture. For example, producers (aka farmers) can use satellite or other imagery of land areas to create plans for working areas of land. As another example, lenders, prospective buyers, and others with an interest in land can use satellite and other imagery of land areas to determine the potential uses or value of land. When viewing land areas using a geospatial platform, it is often useful to draw boundaries within the geospatial platform in order to calculate land area, create prescriptions, or perform many other operations. Currently, when drawing boundaries in a geospatial platform, one has to do a lot of tedious manual drawing of boundaries to separate land that is suitable for a particular purpose from land that is not suitable for that purpose. For example, an area of agricultural land frequently contains tillable areas and non-tillable areas, often with irregularly shaped borders, and hand-selecting or drawing a boundary that omits non-tillable acres can be time consuming and error prone. Therefore, an improved method for drawing boundaries in a geospatial platform based on land use is desired.

### SUMMARY OF THE INVENTION

In accordance with various embodiments of the invention, a computer implemented method for drawing geospatial boundaries based on land use is provided. In one embodiment, a user of a geospatial software platform selects one or more deeded parcels of land on a map. The user may choose dynamic creation of farm fields from geospatial datasets or manual creation of farm fields. If the user selects the option of dynamically creating farm fields from geospatial datasets, a subroutine for dynamically generating a farm field boundary using geospatial datasets is called. The selected parcels are passed as inputs to the subroutine, and the subroutine returns the farm field created by operation of the subroutine as output. Correctness of the fields is verified. If all fields are correct, then the user may save the farm fields to the user's account. If one or more fields are incorrect, then the user may manually edit the fields before saving the farm fields to the user's account.

In accordance with one embodiment, the subroutine for generating one or more farm field boundaries using geospatial datasets may begin with retrieving a first geospatial dataset that overlaps the parcel. The first dataset may comprise Common Land Units (“CLUs”) data provided by the Farm Service Agency (“FSA”), allowing the selected parcels to be categorized and separated into agricultural land and land used for other purposes. Processing of the CLU or other geospatial dataset then begins. The CLU or other geospatial dataset is trimmed to the parcel boundary. If the geospatial dataset spills over any of the parcel boundary lines selected by the user, the subroutine will clip them based on the selected parcel boundaries. If the dataset has any geospatial gaps (i.e. it does not completely fill the parcel boundaries), then the subroutine automatically fills them such that the full parcel boundary can be represented. The resulting parcel area is compared to the minimum allowed acreage, and if it is not greater than the minimum allowed acreage, then the result is discarded, and processing of the CLU dataset ends. Such processing is repeated until all CLUs overlapping the parcel are processed, and the created farm fields are returned to the main algorithm. . . . Otherwise, a farm field is created from the result, the acreage type is assigned to the field using a second geospatial dataset such as the USDA Cropland Data Layer, and processing of the geospatial datasets ends. Such processing is repeated until all CLUs overlapping the parcel are processed, and the created farm fields are returned to the main algorithm.

### BRIEF DESCRIPTION OF DRAWINGS

FIG. 1 illustrates a method for drawing geospatial boundaries based on land use in accordance with one embodiment of the invention.

FIG. 2 illustrates a method for dynamically generating a farm field boundary using a geospatial dataset and a cropland data layer in accordance with one embodiment of the invention.

### DETAILED DESCRIPTION OF THE INVENTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus or method steps are not shown in one or more of the figures for clarity and to facilitate explanation of embodiments of the present invention.

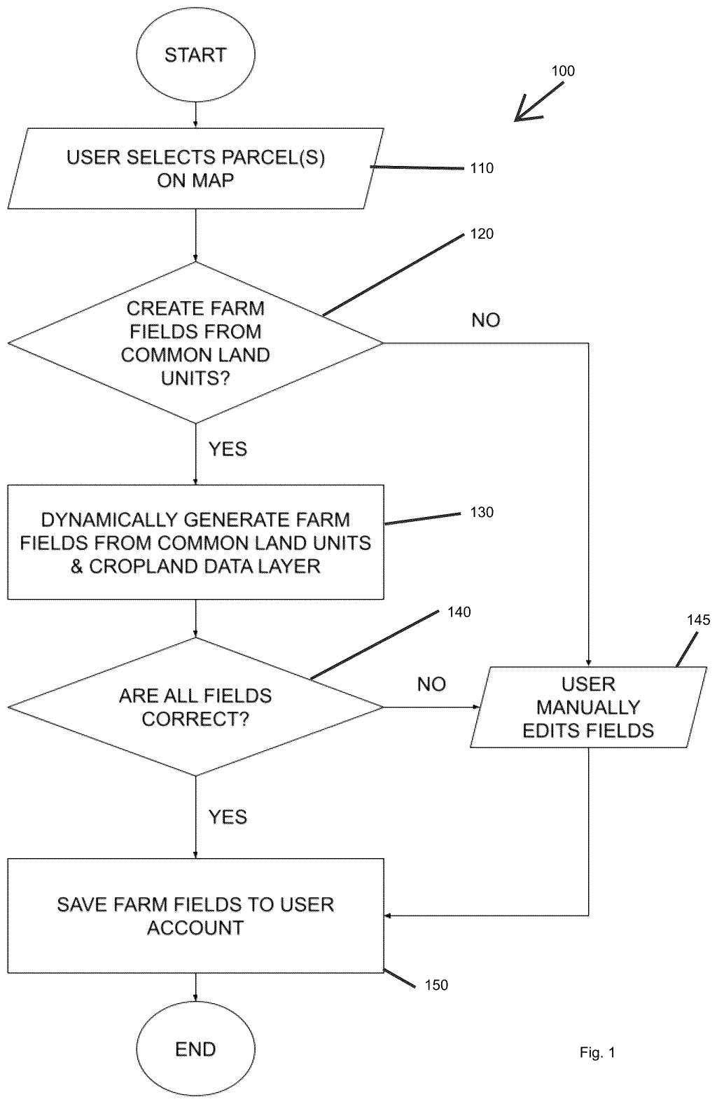

In accordance with one embodiment, FIG. 1 illustrates a method 100 for drawing geospatial boundaries based on land use. The method 100 begins at step 110, in which a user of a geospatial platform selects one or more deeded parcels of land on a map. Selecting the deeded parcels may be achieved when a user enters location data such as an address or geospatial coordinates into a geospatial software platform operating on the user's computing device using a keyboard or similar input device associated with the user's computing device. Parcels of land at or near the entered address or coordinates may then be displayed on a map, satellite image, or similar representation of the area, and the user may zoom and pan the displayed map as needed to find the parcels of interest. The parcel data may be retrieved from a public database such as public tax parcel data and displayed within the software interface. The user may then click or otherwise select parcels of interest using a user input device. The parcels may be contiguous or non-contiguous. The selection of parcels may be indicated by outlining the boundaries of the selected parcels in a different color, pattern, or other distinguishing feature.

The parcels selected at step 110 may include land areas having a use that is of interest to the user and other areas having other uses. For example, the selected parcels may include both tillable acres and non-tillable acres, and the user wishes to create farm fields by separating the tillable acres from the non-tillable acres. At step 120, the user may choose dynamic creation of farm fields from geospatial datasets or manual creation of farm fields. The user may choose dynamic creation of farm fields from geospatial datasets by clicking a button, selecting from a drop-down menu, or similarly selecting an option displayed on the user's screen. In one embodiment, the user may click a button with the language “Create from CLU” or similar language. If the user does not select the Create from CLU button or similar option, this indicates that the user wishes to manually create farm fields, and the method 100 proceeds to step 145. If the user selects the Create from CLU button or similar option, then this indicates that the user wishes to dynamically create farm fields from geospatial datasets, and the method proceeds to step 130.

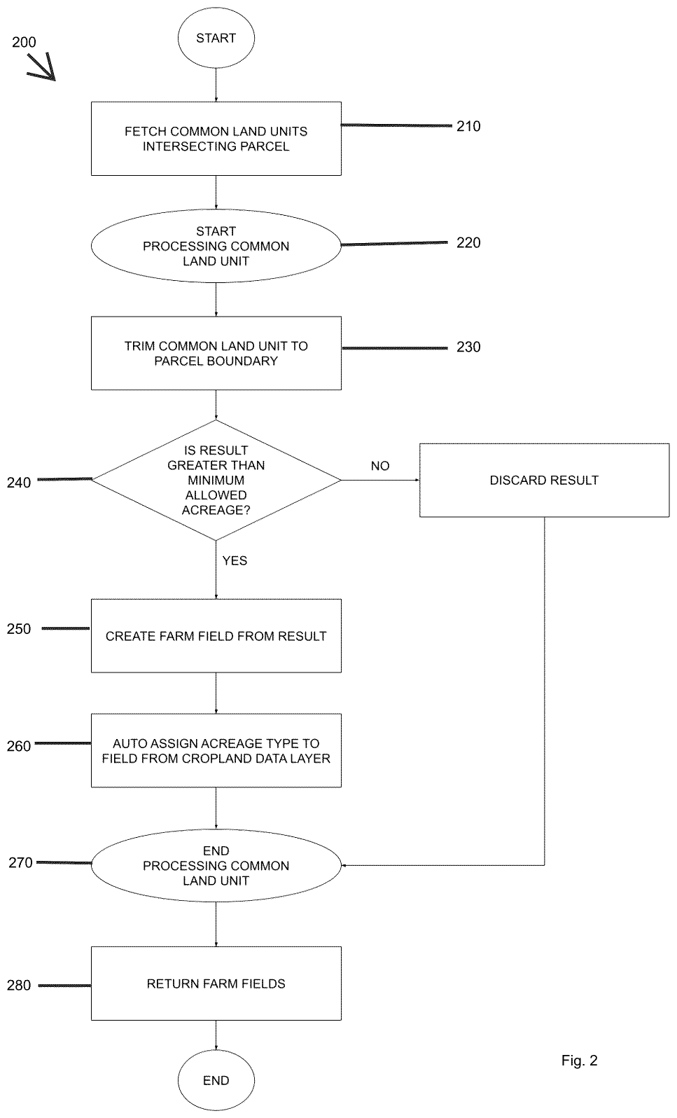

At step 130, the subroutine or method 200 illustrated in FIG. 2 for dynamically generating a farm field boundary using geospatial datasets is called. The parcels selected in step 110 of method 100 are passed as inputs to the method 200. The method 200 proceeds as subsequently described in this disclosure, returning the farm field created at step 250 and the acreage type assigned at step 260, and the method 100 proceeds to step 140.

At step 140, correctness of the fields is verified. Verifying that all fields are correct may entail displaying the boundaries created by the method 200 on a display and allowing the user to visually inspect the boundaries dynamically created by the method 200. If all fields are correct, then the user may save the farm fields to the user's account at step 150. If one or more fields are incorrect, then the user may manually edit the fields at step 145 before saving the farm fields to the user's account at step 150.

In accordance with one embodiment, FIG. 2 illustrates a method 200 for dynamically generating a farm field boundary using a geospatial dataset and a cropland data layer.

The method 200 begins at step 210, in which a first geospatial dataset that overlaps the parcel is fetched or retrieved. The first geospatial dataset may comprise Common Land Units (“CLUs”) data provided by the Farm Service Agency (“FSA”). Use of CLUs allows the selected parcels to be categorized and separated into agricultural land and land used for other purposes. Alternatively, another first or third party geospatial dataset may be used instead of CLUs without departing from the scope of the disclosure. A number of CLUs overlapping the parcel may be fetched or retrieved at step 210.

At step 220, processing of the CLU or other geospatial dataset begins.

At step 230, the CLU or other geospatial dataset is trimmed to the parcel boundary. If the geospatial dataset spills over any of the parcel boundary lines selected by the user, the method 200 will clip them based on the selected parcel boundaries. If the dataset has any geospatial gaps (i.e. it does not completely fill the parcel boundaries), then the method 200 automatically fills them such that the full parcel boundary can be represented.

At step 240, the result from step 230 is compared to the minimum allowed acreage. If the result from step 230 is not greater than the minimum allowed acreage, then the result is discarded and the method 200 proceeds to step 270. If the result from step 230 is greater than the minimum allowed acreage, then the method 200 proceeds to step 250.

At step 250, a farm field is created from the result from step 230.

At step 260, the acreage type is assigned to the field using a second geospatial dataset. The acreage type may be automatically assigned using data from the USDA's Cropland Data Layer, a publicly available dataset that includes data indicative of the use of an area of land. Examples of types of use for an area of land can include agricultural use, woodlands, wetlands, developed land, or other types of land use. Alternatively, another dataset indicative of land use type may be used without departing from the scope of the disclosure.

At step 270, processing of the CLU or other geospatial dataset ends.

Steps 220-270 result in processing of a single CLU. Since a number of CLUs overlapping the parcel may have been fetched or retrieved at step 210, steps 220-270 are performed repeatedly or as a loop as neededuntil all CLUs retrieved at step 210 are processed. Accordingly, a number of farm fields are created by operation of the repeated performance of steps 220-270.

At step 280, the one or more farm fields created through performance of steps 220-270 are returned to the method 100 main algorithm.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer implemented method for dynamically generating a farm field boundary separating tillable acres from non-tillable acres comprising:
receiving a location information input;
displaying a map depicting an area represented by the location information input on a display device;
receiving an input of one or more land parcel selections, wherein each of the one or more land parcel selections has a boundary;
retrieving a first geospatial dataset that overlaps the one or more land parcel selections;
trimming the first geospatial dataset to match the boundaries of the one or more land parcel selections to create trimmed parcel boundaries;
comparing the trimmed parcel boundaries to a minimum allowed acreage, and creating a farm field if the area of the trimmed parcel boundaries is greater than the minimum allowed acreage;
retrieving a second geospatial dataset that overlaps the one or more land parcel selections, the second geospatial dataset being indicative of a land use for the farm field; and
assigning an acreage type to the farm field using a second geospatial dataset, the acreage type indicating tillable and non-tillable acres of the farm field.

2. The method of claim 1 wherein displaying a map depicting an area represented by the location information input on a display comprises receiving tax parcel data from a database and displaying land ownership boundary data contained in the tax parcel data on the map.

3. The method of claim 1 wherein the first geospatial dataset comprises a Common Land Units dataset.

4. The method of claim 1 wherein trimming the first geospatial dataset further comprises filling any geospatial gaps such that boundaries of the one or more land parcel selections are fully represented.

5. The method of claim 1 wherein the second geospatial dataset comprises a Cropland Data Layer dataset.
